(19) United States
(12) Patent Application Publication
(10) Pub. No.: US 2008/0110840 A1
(43) Pub. Date: May 15, 2008

(54) Modular desk organizer

(75) Inventors: Craighton Berman, Chicago, IL (US); Kurt Sward, Deerfield, IL (US)

Correspondence Address: MCDERMOTT, WILL & EMERY LLP, 227 WEST MONROE STREET, SUITE 4400, CHICAGO, IL, 60606-5096, US

(73) Assignee: Ignite USA, LLC.

(21) Appl. No.: 11/588,127

(22) Filed: Oct. 26, 2006

(51) Int. Cl. B42F 17/00

(52) U.S. Cl. 211/11

(57) ABSTRACT

The present invention generally provides a customizable modular organizer. The modular organizer has a backing board and a plurality of substantially linear holders provided on the first side of the backing board. The holders are connected to the backing board at connection points to define a plurality of openings between the backing board and the holders. The openings are adapted to removably accept desk organizer attachments therein. Preferably, the holders are vertically aligned and connected to the backing board in an orientation to create a plurality of columns of vertical openings. Additionally, in one embodiment the removable desk organizer attachment has a substantially planar flap sized to fit in one or more of the openings of the organizer to removably secure the organizer attachment therein.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates generally to a modular organizer, and more specifically to a modular desk pad adapted to hold a variety of items, such as a calendar, note pad, adhesive note holder, document tray, etc., in a variety of positions and locations thereon as desired by the user.

### BACKGROUND OF THE INVENTION

Desk pads are well known in the art. While such desk pads according to the prior art provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides a customizable modular desk pad. According to one embodiment the modular desk pad comprises a backing board and a plurality of substantially linear holders provided on a first side of the backing board. The holders are connected to the backing board at connection points to define a plurality of openings between the backing board and the holders. The openings are adapted to removably accept desk organizer attachments therein.

According to another embodiment, the backing board has a first side and a second side, and the holders are provided on the first side of the backing board. Preferably, the holders are provided in a plurality of rows on the first side of the backing board. More preferably, the holders comprise a plurality of rows of straps secured to the backing board at connection points about a length of the straps to define openings between the backing board and the strap, the openings being linearly located on the desk organizer.

According to another embodiment, a connector is provided on the second or back side of the backing board. The connector is adapted to secure the modular desk pad on, for example, a wall.

According to another embodiment, the customizable desk organizer has at least one removable desk organizer attachment. The attachment has a substantially planar flap sized to fit in one or more of the openings of the organizer to secure the desk organizer attachment to the backing board in the desired opening. In various embodiments the removable desk organizer attachment comprises a calendar, note pad and/or note dispenser.

According to another embodiment, the modular desk pad has a backer, a first holding strap and a second holding strap. The backer is substantially planar and has a first side, a second side and a top edge. The first holding strap is generally linear and has a first end and a second end. The first holding strap is connected to the first side of the backer at least at three connection points: the first connection point being adjacent the first end of the first holding strap, the second connection point being adjacent the second end of the first holding strap, and the third connection point being a position between the first and second connection points. Further, a first opening in the first holding strap is defined between the first and third connection points, and a second opening in the first holding strap is defined between the second and third connection points. The first and second openings are adapted to removably accept desk pad attachments therein. Similarly, the second holding strap is generally linear and has a first end and a second end. The second holding strap is connected to the first side of the backer at least at three connection points: the first connection point being adjacent the first end of the second holding strap, the second connection point being adjacent the second end of the second holding strap, and the third connection point being a position between the first and second connection points. The second holding strap is positioned on the backer a greater distance from the top edge than the first holding strap. Further, a first opening in the second holding strap is defined between the first and third connection points, and a second opening in the second holding strap is defined between the second and third connection points. The first and second openings are adapted to removably accept desk pad attachments therein.

According to another embodiment of the modular desk pad, the first, second and third connection points of the first holding strap are vertically aligned, respectively, with the first, second and third connection points of the second holding strap.

According to another embodiment, the modular desk pad comprises a backer and a first retaining means. The backer has a first side and a second side, and the first retaining means extends generally horizontally across the first side of the backing board and is connected to the backing board at connection points to create a plurality of columns of vertical openings. The retaining means is adapted to hold a variety of items in customizable configurations.

According to yet another embodiment, the modular desk pad further comprises a second retaining means extending generally horizontally across the first side of the backing board and is connected to the backing board at connection points to create a plurality of columns of vertical openings. The openings of the second retaining means align with the openings of the first retaining means.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of one embodiment of the modular desk organizer;

FIG. 2 is an exploded view of another embodiment of the modular desk organizer;

FIG. 3 is a perspective view of another embodiment of the modular desk organizer;

FIG. 4 is a top view of one embodiment of a component for the modular desk organizer;

FIG. 5 is a partial top view of a component for the modular desk organizer being inserted into an opening of the modular desk organizer; and,

FIG. 6 is a cross-sectional view of the modular desk organizer about line 6-6 of FIG. 5.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

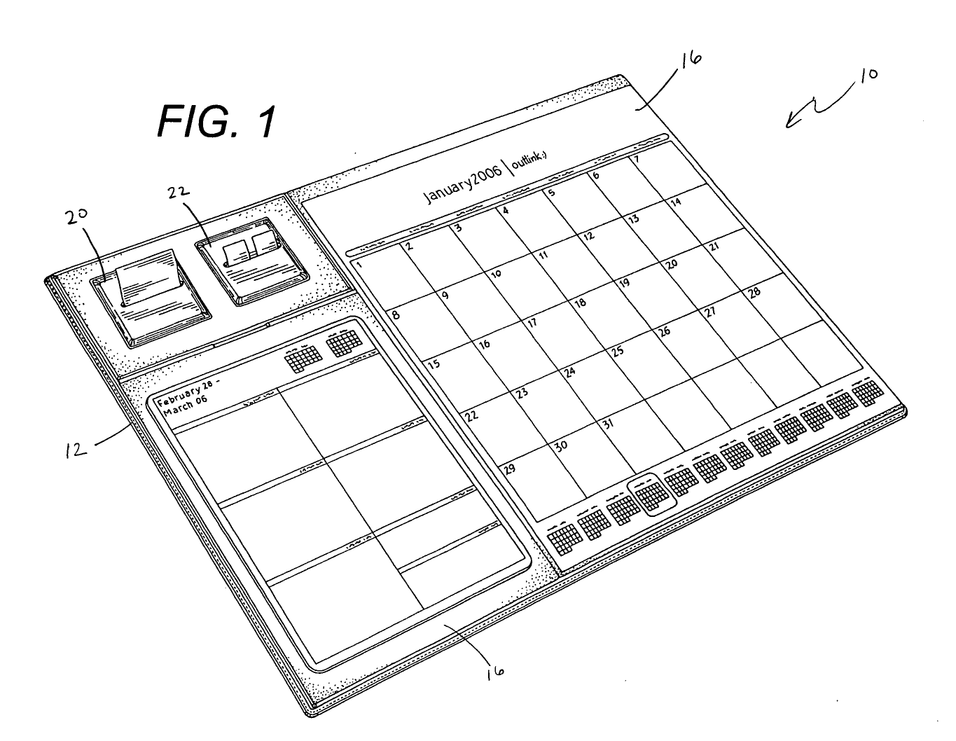

Referring now to the Figures, and specifically to FIGS. 1-3, there is shown a customizable modular desk organizer 10 or modular desk pad 10. The modular desk pad 10 generally comprises a desk pad backer or backing board 12 and a plurality of retaining means 14. In different embodiments the modular desk pad 10 also utilizes various insert attachments or components 25, such as a calendar 16, note pad 18, post-it notes 20, tab stickers 22, document tray 23, etc. The modular desk pad 10 can be placed on a flat surface, such as a desk, or hung from a vertical surface, such as a wall, with the use of a connector 24. Because a different combination of insert components, also referred to as attachments, can be utilized with the desk organizer 10, the desk organizer 10 is both modular and customizable. Further, the various attachments can be connected to the backer board 12 in a variety of different positions, rendering the desk organizer 10 further modular and customizable. While the overall system is referred to as a desk organizer or desk pad, it is understood that the system need not be utilized on a desk or even a horizontal surface, and can be utilized on a vertical surface such as a wall as is explained in detail herein.

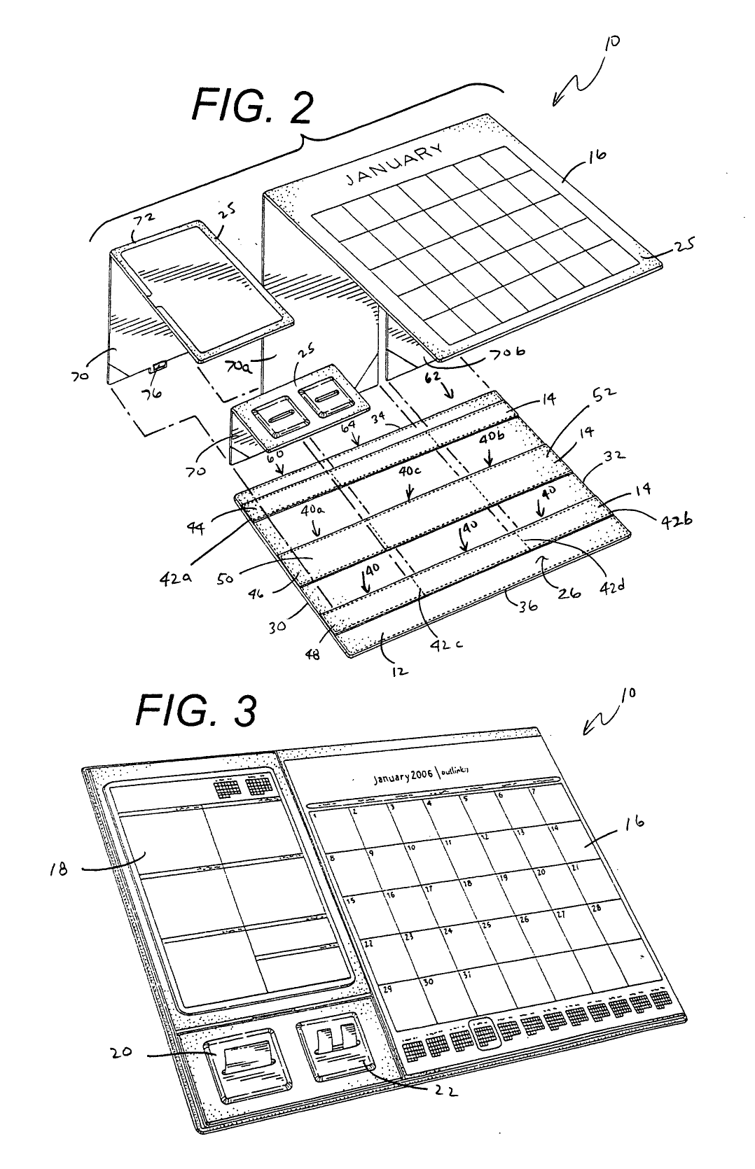

The backing board 12 for the desk organizer or desk pad 10 is preferably a substantially planar component that has a first side 26 and a second side 28 (See FIGS. 2 and 6). In one embodiment, as shown in FIG. 2, the backing board 12 is generally rectangular in shape and has a first side edge 30, an opposing second side edge 32, a third top edge 34 and an opposing fourth bottom edge 36. The backing board 12 is the base component on which additional components, including the holders 14, are positioned to create the overall modular organizer 10.

The retaining means 14 of the desk organizer 10 are connected to the backing board 12 to provide openings 40 utilized to secure different insert components to the backing board 12. In one embodiment the retaining means 14 are holders 14 comprised of straps 14 connected to the backing board 12 at different connection points 42. Further, in a preferred embodiment the areas between the connection points 42 in one respect, and the area between the backing board 12 and the holder 14 in another respect, define the openings 40 into which a portion of the insert components are inserted to retain the insert components to the backing board 12.

Referring to FIGS. 2, 5 and 6, a plurality of retaining means 14 are provided on the first side 26 of the backing board 12. In one embodiment the retaining means 14 are substantially linear holders 14 that extend generally horizontally across the backing board 12. While the holders 14 are shown as linear straps in many embodiments herein, it is understood that other configurations and components may be utilized as holders, such as pockets, bars, rods, grippers, fastening means, etc. In a preferred embodiment the linear straps 14 are made of either a nylon material or an elastic material and are sewn to the backing board 12 at the appropriate connection points 42. Further, in a preferred embodiment the plurality of linear holders 14 are provided in a plurality of rows on the first side 26 of the backing board 12. In the embodiment of FIG. 2, three rows of linear holders 14 are provided on the first side 26 of the backing board 12, however, it is understood by those having ordinary skill in the art that a smaller number or greater number of holders 14 may be provided on the backing board 12 without departing from the spirit and scope of the present invention. In this embodiment the first row 44 of holders 14 is provided toward the top edge 34 of the backing board 12, the third row 48 of holders 14 is provided toward the bottom edge 36 of the backing board 12, and the second row 46 of holders 14 is provided between the first row 44 and the third row 48 of holders 14. Accordingly, the second and third rows 46, 48 of holders 14 are positioned on the backer 12 a greater distance from the top edge 34 than the first row 44 of holders 14.

Referring to FIG. 6, the holders 14 are connected to the backing board 12 at connection points 42 to define the plurality of openings 40 between the backing board 12 and the holders 14. As explained herein, the openings 40 are adapted to removably accept the desk organizer attachments, such as for example a calendar 16, a note pad 18, post-it notes 20, tab stickers 22, a document tray 23, or any of a variety of other desk organizer attachments therein. In a preferred embodiment wherein the holders 14 are linear straps, the holders 14 have a first end 50 and a second end 52. The first end 50 of the holders 14 are located toward the first side edge 30 of the backer board 12, and the second end 52 of the holders 14 are located toward the second side edge 32 of the backer board 12. Preferably, the holder 14 is connected to the backing board 12 at least at three connection points 42 spaced linearly about a length of the holder 14. The first connection point 42a between the holder 14 and the backing board 12 being adjacent the first end 50 of the holder 14, the second connection point 42b between the holder 14 and the backing board 12 being adjacent the second end 52 of the holder 14, and the third connection point 42c between the holder 14 and the backing board 12 being a position between the first connection point 42a and the second connection point 42b. Additionally, it is understood that additional connection points 42 may be provided between the holder 14 and the backing board 12 to provide additional openings 40 for retaining insert components therein. For example, in the embodiment of FIG. 2 four connection points 42a, 42b, 42c and 42d are provided between each holder 14 and the backing board 12. In this embodiment the fourth connection point 42d is provided between the first and second connection points 42a and 42b, similar to the third connection point 42c. It is further understood that each holder 14 on the backing board 12 may not have the same number of connection points 42 as the other holders 14 on the organizer 10.

When the holder 14 is connected to the backing board 12 at three connection points 42a at one end 50, 42b at an opposing end 52 and 42c between the first and second connection points 42a, 42b, two openings 40a and 40b are defined. The first opening 40a is defined between the first connection point 42a and its adjacent connection point, i.e., the third connection point 42c. Similarly, the second opening 40b is defined between the second connection point 42b and its adjacent connection point, i.e., the third connection point 42c. Each of the openings 40a, 40b are adapted to removably accept desk pad attachments therein.

Referring again to FIG. 2, in this embodiment four connection points 42a, 42b, 42c, 42d are provided for each row 44, 46, 48 of holders 14. When four connection points 42a, 42b, 42c, 42d are provided, three distinct openings 40a, 40b, 40c for this holder 14 are defined. A first opening 40a is provided between the holder 14 and the backing board 12 and laterally defined by the first connection point 42a and the third connection point 42c, a second opening 40b is provided between the holder 14 and the backing board 12 and laterally defined by the fourth connection point 42d and the second connection point 42b, and a third opening 40c is provided between the holder 14 and the backing board 12 and laterally defined by the third connection point 42c and the fourth connection point 42d. Alternatively, however, the opening 40 may be provided directly in the holder 14, depending on the configuration, structure and/or geometry of the holder 14.

In one embodiment, as shown in FIG. 2, the openings 40 of different holders 14, and in some embodiments the connection points 42 of the openings 40 of different rows of adjacent holders 14, are linearly located and vertically aligned with each other, respectively, to create vertically aligned columns of openings. Referring to FIG. 2, three columns of openings are provided on this embodiment: a first column 60 of openings 40 is provided adjacent the first side edge 30 of the backing board 12, a second column 62 of openings 42 is provided adjacent the second side edge 32 of the backing board 12, and a third column 64 of openings 40 is provided between the first column 60 and the second column 62 of openings. Accordingly, the first column 60 of openings 40 is defined by the first opening 40a in a plurality of rows of holders 14, the second column 62 of openings 40 is defined by the second opening 40b in a plurality of rows of holders 14, and the third column 64 is defined by the third opening 40c in a plurality of rows of holders 14. In a preferred embodiment, as shown in FIG. 2, the first column 60 of openings 40 is defined by the first openings 40a in the first, second and third rows 44, 46 and 48 of holders 14, the second column 62 of openings 40 is defined by the second openings 40b in the first, second and third rows 44, 46 and 48 of holders 14, and the third column 64 of openings 40 is defined by the third openings 40c in the first, second and third rows 44, 46 and 48 of holders 14. Additionally, in this embodiment the first column 60 of openings 40 is defined by the openings 40 between the first and third connection points 42a, 42c, the second column 62 of openings 40 is defined the openings 40 between the fourth and second connection points 42d and 42b, and the third column 64 of openings 40 is defined by the openings 40 between the third and fourth connection points 42c and 42d.

The openings 40 operate as receivers for the insert components. Referring to FIGS. 2 and 4-6, the different insert components 25 have components flaps 70 extending therefrom which extend into one or more openings 40 of the desk organizer 10. In one embodiment the flap 70 extends from an end 72 of the insert component 25, however, in alternate embodiments the flap 70 can extend from a location other than an end 72 of the insert component 25. Typically the flap 70 has a length that extends approximately the same distance as the height of the insert component 25. In this configuration the insert component 25 will be more securely fixed in the desk organizer 10. The flap 70 is preferably sized to fit in one or more of the openings 40 of the desk organizer 10, typically openings 40 within the same vertical column as described herein.

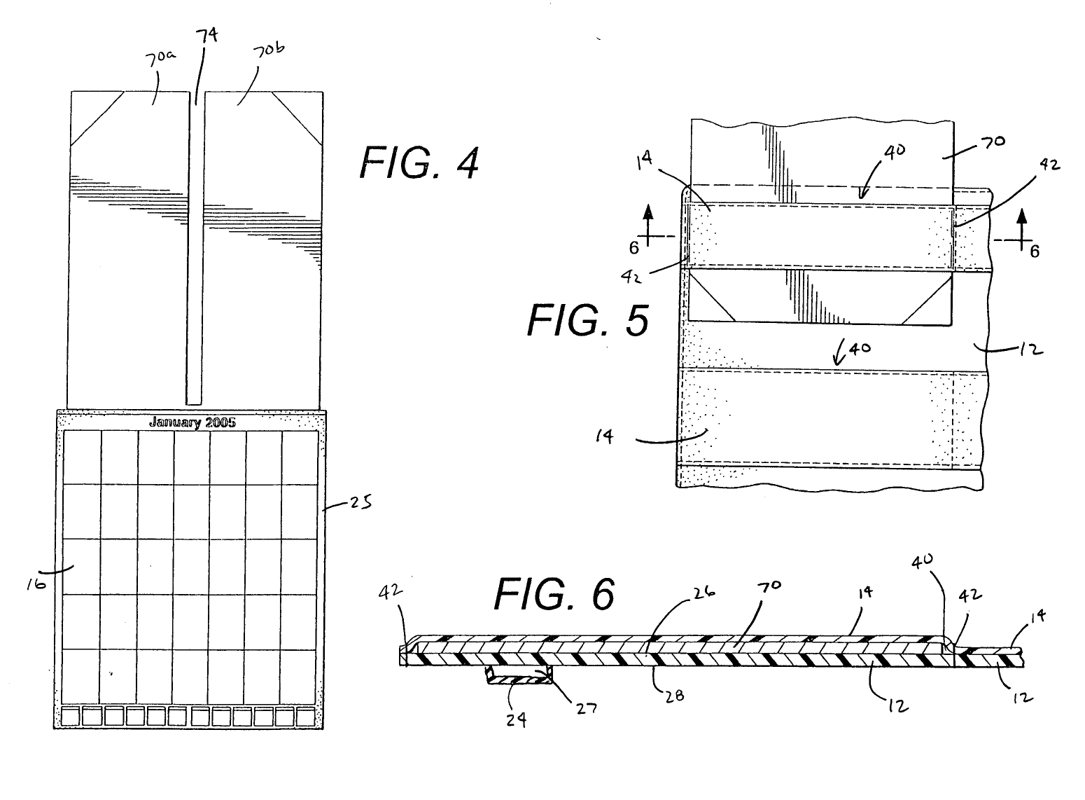

As shown in FIGS. 2, 5 and 6, in one embodiment the flaps 70 of the insert components 25 are substantially planar components that are able to be slid into and out of (as desired by the user) the openings 40 between the holders 14 and the backing board 12. Further, as shown in FIG. 4, the flap 70 may be comprised of two components, a first flap 70a and a second flap 70b, or in an alternate embodiment more than one flap 70 or other retaining component may be provided. In this embodiment a gap or space 74 is provided between the flaps 70a and 70b to account for the connection point 24 between the holder 14 and the backing board 12 during connection therebetween as shown in FIG. 2. When the flaps 70 are inserted into an opening 40 the holder 14 secures the insert component 25 to the backing board 12.

Depending on the size of the desk organizer insert 25, the flap 70 may be inserted into one or more openings 40 in one or more rows of holders 14. For example, in FIG. 2, the document tray 23 insert component 25 has a flap 70 which is inserted into both the first opening 40a in the first row 44 of holders 14 as well as the first opening 40a in the second row 46 of holders 14. A combination post-it note 20 and tab sticker 22 insert component 25 is also utilized in this embodiment of the modular desk organizer 10. This insert component 25 has a flap 70 which is inserted into only one opening, i.e., the first opening 40a in the third row 48 of holders 14. Finally, this embodiment of the modular desk organizer 10 has a calendar 16 insert component 25. The calendar 16 insert component 25 has a first flap 70a and a second flap 70 as shown in FIGS. 2 and 4. The first flap 70a of the calendar 16 is inserted into three openings 40, those being the third opening 40c in each of the first row 44, second row 46 and third row 48 of holders 14, and the second flap 70b of the calendar 16 is inserted into three openings 40, those being the second opening 40b in each of the first row 44, second row 46 and third row 48 of holders 14.

The insert component 25 may also have a fastener 76 to assist in securing the insert component 25 to the modular desk organizer 10. In one embodiment the fastener 76 is provided on the flap 70 to the body of the removable desk organizer attachment/insert component 25. The fastener 76 may be any component that assists in securing the flap in place with respect to the holder 14, such as Velcro, a snap, button, zipper, etc. Referring to FIG. 2, in a preferred embodiment the fastener 76 is a Velcro component that is provided toward the end of the flap 70 and which mates with a mating Velcro component (not shown) on the back surface of the insert component 25.

Referring now to FIG. 6, the modular organizer 10 may also have at least one connector 24 on the second side 28 of the backing board 12, and preferably two connectors 24 depending on the size of the modular organizer 10. The connector 24 is typically utilized to allow the modular organizer 10 to be hung in a more vertical manner, such as on a wall. In one embodiment the connector 24 has an opening 27 to receive a fastener, such as a nail or screw extending from a wall, to secure the modular organizer 10 in place. Alternately, the connector 24 may have an adhesive component, including such as a double-sided tape, to secure the modular organizer 10 in place. Such a connector 24 may be utilized not only to secure the modular organizer 10 in a vertical position, but also in a horizontal position on a desk or counter-top as well as in any other orientation.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A customizable modular desk organizer comprising:
a backing board having a first side and a second side (edges in the detailed description), and a plurality of substantially linear holders provided on the first side of the backing board, the holders being connected to the backing board at connection points to define a plurality of openings between the backing board and the holders, the openings adapted to removably accept desk organizer attachments therein.

2. The modular desk organizer of claim 1, wherein the holders are substantially planar.

3. The modular desk organizer of claim 1, wherein the holders are provided in a plurality of rows on the first side of the backing board.

4. The modular desk organizer of claim 1, wherein the holders comprise a plurality of rows of straps secured to the backing board at connection points about a length of the straps to define openings between the backing board and the strap, the openings being linearly located on the desk organizer.

5. The modular desk organizer of claim 1, wherein each holder has at least 3 connection points spaced linearly about a length of the holder.

6. The modular desk organizer of claim 3, wherein the connection points of different rows of holders are aligned to create vertically aligned openings.

7. The modular desk organizer of claim 1, further comprising a connector on the second side of the backing board.

8. The modular desk organizer of claim 7, wherein the connector has an opening to receive a fastener to hold the backing board in place respecting the fastener.

9. The modular desk organizer of claim 7, wherein the connector has an adhesive component to secure the backing board in place.

10. The modular desk organizer of claim 1, further comprising a removable desk organizer attachment having a substantially planar flap sized to fit in one or more of the openings of the organizer, the holders securing the desk organizer attachment to the backing board in the desired opening.

11. The modular desk organizer of claim 10, wherein the removable desk organizer attachment comprises one of a calendar, note pad and note dispenser.

12. The modular desk organizer of claim 10, further comprising a fastener on the flap to secure the flap to a body of the removable desk organizer attachment around the holder.

13. The modular desk organizer of claim 10, wherein the flap comprises a first flap and a second flap with a space therebetween, the first flap adapted to be inserted into a first opening of the holder and the second flap adapted to be inserted into an adjacent second opening of the holder, and wherein one of the connection points is provided between the first and second flaps.

14. A modular desk pad, comprising:
a substantially planar backer having a first side, a second side and a top edge;
a first linear holding strap having a first end and a second end, the first holding strap being connected to the first side of the backer at least at three connection points, the first connection point being adjacent the first end of the first holding strap, the second connection point being adjacent the second end of the first holding strap, and the third connection point being a position between the first and second connection points, wherein a first opening is defined between the first and third connection points, and wherein a second opening is defined between the second and third connection points, the first and second openings adapted to removably accept desk pad attachments therein; and,
a second linear holding strap having a first end and a second end, the second holding strap being connected to the first side of the backer at least at three connection points, the first connection point being adjacent the first end of the second holding strap, the second connection point being adjacent the second end of the second holding strap, and the third connection point being a position between the first and second connection points, wherein the second holding strap is positioned on the backer a greater distance from the top edge than the first holding strap, wherein a first opening is defined between the first and third connection points, and wherein a second opening is defined between the second and third connection points, the first and second openings adapted to removably accept desk pad attachments therein.

15. The modular desk pad of claim 14, wherein the first, second and third connection points of the first holding strap are vertically aligned, respectively, with the first, second and third connection points of the second holding strap.

16. A modular desk pad comprising:
a backer having a first side and a second side;
a first retaining means extending generally horizontally across the first side of the backing board and being connected to the backing board at connection points to create a plurality of columns of vertical openings, the retaining means adapted to hold a variety of items in customizable configurations.

17. The modular desk pad of claim 16, further comprising a second retaining means extending generally horizontally across the first side of the backing board and being connected to the backing board at connection points to create a plurality of columns of vertical openings, the openings of the second retaining means aligning with the openings of the first retaining means.
